(19) United States
(12) Patent Application Publication
(10) Pub. No.: US 2026/0099371 A1
(43) Pub. Date: Apr. 9, 2026

(54) Integrated Workload Right-Sizing And Node Scaling Operations

(71) Applicant: NetApp, Inc., San Jose, CA (US)

(72) Inventors: Yarden Joshua Kesari, Ashkelon (IL); Revital Vladimirsky, Petah Tikva (IL)

(73) Assignee: NetApp, Inc., San Jose, CA (US)

(21) Appl. No.: 18/905,727

(22) Filed: Oct. 3, 2024

(51) Int. Cl. G06F 9/50

(52) U.S. Cl. CPC G06F 9/5027

(57) ABSTRACT

The disclosure describes a node management service that integrates right-sizing and node scaling operations. The node management service modifies a request parameter for a workload deployed in a compute cluster. The node management service determines an updated set of compute nodes for nodes affected by the updated request parameter. The node management service obtains, from a compute provider, the updated set of compute nodes for the compute cluster. The node management service provides the modified request parameter to a control plane after obtaining the updated set of compute nodes.

### BACKGROUND

In a compute cluster, workloads are assigned request parameters that specify the minimum amount of memory and CPU processing resources required to schedule the workload’s pods to nodes in a compute cluster (e.g., a Kubernetes cluster). Overprovisioning occurs when these request parameters are set higher than the actual resource usage of the workload, leading to unnecessary costs, especially when the workload involves a large number of pods. To mitigate this, developers employ “right-sizing” techniques, which adjust the request parameters to more accurately reflect the workload’s actual resource demands.

Right-sizing workloads helps optimize request parameters of the workloads within the compute cluster. However, existing systems do not efficiently manage node scaling after right-sizing adjustments are made. For instance, when the request parameters are reduced, these systems often analyze the compute cluster on a node-by-node basis to decide whether each node should be replaced with a smaller node. In large clusters (e.g., those with hundreds of nodes), this approach can be time-consuming and inefficient, and may lead to sub-optimal load arrangements.

### SUMMARY

The disclosure describes a node management service that integrates right-sizing and auto-scaling processes to alleviate the above-described issues. The node management service modifies a request parameter for a workload having one or more pods in a compute cluster. The request identifies a minimum amount of compute resources sought for each of the one or more pods. The node management service then identifies an initial set of nodes in the compute cluster affected by this change. It then simulates deployment of the workload with the modified request parameter to determine an updated set of compute nodes in the compute cluster. Once the simulation is over, the node management service immediately adds new compute nodes to the compute cluster to replace the existing nodes, in order to accommodate the updated request parameter. This process ensures that the compute nodes in the cluster are fully utilized. By integrating right-sizing and node-scaling into a single process, this service ensures that the compute cluster has an appropriately sized set of nodes before the pods in the updated workload are scheduled.

### BRIEF DESCRIPTION OF THE DRAWINGS

FIG. 1 illustrates a computing environment in an implementation.

FIG. 2 illustrates an integrated node scaling process in an implementation.

FIG. 3 illustrates an operational sequence in an implementation.

FIG. 4 illustrates a user interface in an implementation.

FIG. 5 illustrates a computing system suitable for implementing the various operational environments, architectures, environments, processes, scenarios, sequences, and frameworks discussed below with respect to the other Figures.

### DETAILED DESCRIPTION

A node management service is described that integrates workload right-sizing with node scaling in a compute cluster. This service monitors workloads running in the cluster and identifies when a workload is overprovisioned, meaning the workload’s request parameter allocates computer resources than the pods in the workload actually use. The service then calculates an updated request parameter to appropriately size the workload.

The rightsizing of the request parameter triggers a node scaling operation, where the node management service determines a more efficient set of nodes to handle the workload. The service simulates the deployment of the updated workload (having the updated request parameter) to identify an updated set of nodes. This new configuration might involve fewer nodes or nodes with different specifications. For instance, it may be more efficient to run the workload on a smaller number of higher-capacity nodes. In some cases, the simulation is designed to optimize the cost of running the workload. Once the service identifies the updated set of nodes, it procures them from a compute provider and implements them in the cluster.

In existing solutions, each node is analyzed individually to determine if it can be replaced by a smaller node when an updated workload is deployed. This approach is inefficient, especially for large workloads that involve many nodes. Analyzing nodes one by one is time-consuming and can delay the optimization of the workload’s size. As a result, this process not only slows down operations but also leads to cost inefficiencies, as resources are not optimized in a timely manner. The solution described here accelerates the process by proactively scaling up suitable nodes as soon as a right-sizing determination is made. This integration of automatic rightsizing with proactive node-scaling quickly achieves the optimal cluster size, resulting in cost savings for customers running applications.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of a node management service; 2) non-routine and unconventional operations for integrating right-sizing and node scaling operations; 3) dynamic modification of a compute cluster, and/or 4) non-routine and unconventional use of the request parameter.

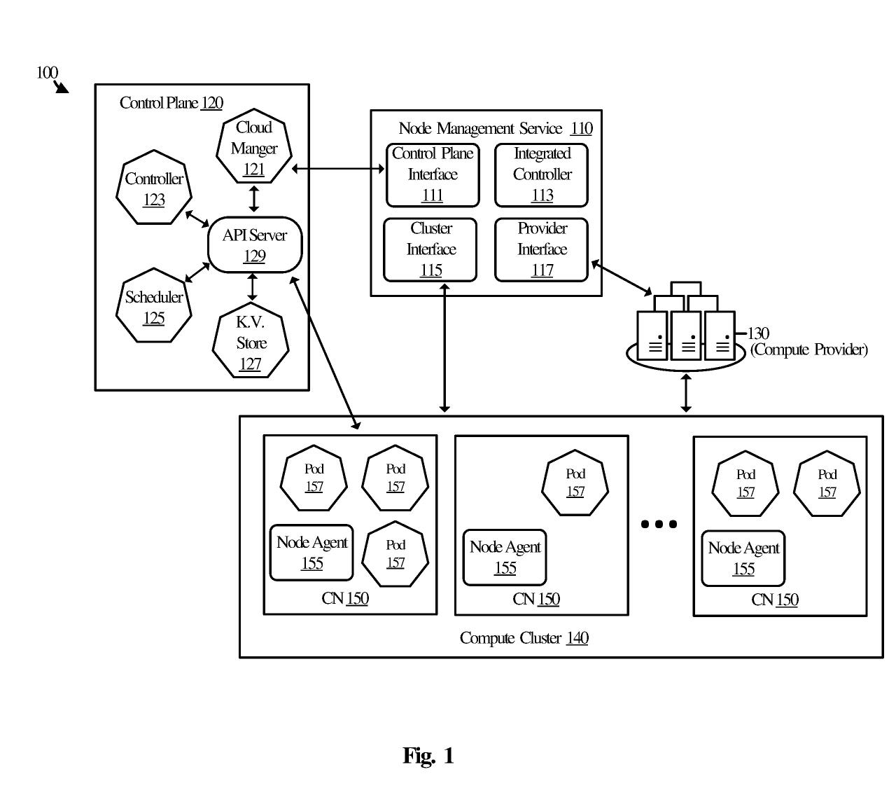

FIG. 1 illustrates computing environment 100 in an implementation. Computing environment 100 includes node management service 110, control plane 120, compute provider 130, and compute cluster 140. Node management service 110 is in communication with control plane 120, compute provider 130, and compute cluster 140. Control plane 120 is in communication with node management service 110 and compute cluster 140. Compute provider 130 is in communication with node management service 110 and compute cluster 140.

Node management service 110 is representative of a software service that manages compute nodes 150 in compute cluster 140. Node management service 110 may be, for example, Spot Ocean. Node management service 110 includes control plane interface 111, integrated controller 113, cluster interface 115, and provider interface 117. Node management service 110 may be a cloud-based service utilized by customers running applications in compute cluster 140.

Integrated controller 113 is a controller of node management service 110 that is configured to integrate right-sizing and node management operations. Integrated controller 113 monitors usage statistics of compute cluster 140 to determine when a workload is overprovisioned. A workload may include multiple pods 157 distributed across various compute nodes 150 in compute cluster 140. The usage statistics are gathered by a specialized application running in pod 157 within compute cluster 140 and are then communicated to node management service 110 via cluster interface 115. The usage statistics may include information about how much CPU and memory is being actively utilized by pods in the workload.

Integrated controller 113 identifies that the workload is overprovisioned when one or more request parameters of the workload are higher than needed in light of the usage statistics. The request parameters represent the minimum amount of compute resources that should be available in a compute node 150 for a pod 157 in the workload to be scheduled and deployed to the node 150 (as explained further in the discussion of control plane 120 below). Integrated controller 113 may determine that compute resources are over-provisioned if the actual usage consistently falls below the request value by a predetermined amount for a threshold period of time. For instance, consider a pod 157 with a CPU request value of 500 millicores and a memory request value of 1 GB. If the pod’s actual CPU usage remains below 250 millicores (50% of the request) and/or its memory usage stays under 500 MB for a sustained period (e.g., 15 minutes). Integrated controller 113 would identify this as an over-provisioned situation. In this scenario, because the actual resource usage is significantly lower than the requested resources, pod 157 is allocated more resources than it needs. Integrated controller 113 can then initiate a right-sizing process to adjust the request values downward.

The right-sizing process involves determining new request parameters (e.g., CPU and memory values) to implement for the pods 157 in the workload. These parameters can be derived using various methods, including analyzing historical usage data to align resource requests with typical usage patterns. Predictive techniques may also be employed, forecasting future resource needs based on trends and workload behavior, such as anticipating spikes in demand at specific times. Trained machine-learning models, or rules-based algorithms may be used to identify the request parameters in various implementations. Once the updated request parameters are determined, control plane interface 111 provides the updated request parameters to cloud manager 121 of control plane 120. Control plane 120 updates the workload with the updated request parameters, as explained further below in the discussion of control plane 120.

Once integrated controller 113 has determined one or more updated request parameters, it initiates a node-scaling process. The node scaling process is triggered by the determination of the updated request parameter. This node-scaling process may begin before the updated request parameters are provided to control plane 120, or before the control plane 120 attempts to schedule and deploy the updated workload in various implementations.

In this scaling process, integrated controller 113 begins by identifying the compute nodes 150 that are affected by the updated request parameters, specifically, those nodes that are currently running pods 157 from the workload with the revised parameters. To optimize resource allocation, integrated controller 113 runs a detailed simulation to determine an optimal set of compute nodes for hosting the updated workload.

This simulation involves simulating deployment of the pods with their updated request parameters across different configurations of compute nodes. The integrated controller assesses how these pods would perform if placed on nodes of varying sizes and capacities. For example, the simulation might test scenarios where the pods are deployed on a smaller number of larger nodes, or alternatively, distributed across a greater number of smaller nodes. The simulation determines a node configuration that balances resource utilization, performance, and cost-effectiveness.

During the simulation, integrated controller 113 takes into account several factors, such as the computational power and memory capacity of each node, the communication overhead between nodes, and the potential impact on application performance. The simulation may be configured to perform cost-optimization in some implementations. To this end, integrated controller 113 evaluates the cost implications of different node configurations, looking for ways to minimize operational expenses. For instance, the simulation might reveal that consolidating the workload onto fewer, more powerful nodes can lower costs. Conversely, it might suggest distributing the pods more widely if that approach leads to better performance and lower long-term costs.

Once the simulation identifies the optimal node configuration, node management service 110 implements the configurajtion in compute cluster 140. Specifically, provider interface 117 submits requests for the updated nodes called for in the updated configuration to compute provider 130, as explained further below.

Control plane interface 111 communicates with control plane 120, specifically with cloud manager 121, to exchange information. It is responsible for forwarding updated request values (calculated by integrated controller 113 as discussed above) to cloud manager 121. Additionally, control plane interface 111 may transmit other essential data, such as identification and addressing details for compute nodes 150 within compute cluster 140, to assist control plane 120 in scheduling pods 157. Moreover, control plane interface 111 can receive important information from control plane 120 that influences node scheduling decisions, including notifications that certain pods are unschedulable, details about the number of replicas, and other relevant data.

Cluster interface 115 interfaces with compute cluster 140. Cluster interface 115 receives usage statistics from compute cluster 140 which are utilized by integrated controller 113 to update request parameters, as discussed above. Cluster interface 115 may also monitor the health and status of nodes 150 and pods 157, and detect issues like node failures., and facilitates scaling operations.

Provider interface 117 interfaces with compute provider 130 to manage the provisioning and decommissioning of nodes 150 within node cluster 140. When integrated controller 113 determines an updated set of nodes for the workload, provider interface 117 submits requests to acquire these new nodes from compute provider 130. Additionally, Provider interface 117 can also initiate the removal of underutilized or unnecessary compute nodes 150, helping to maintain an appropriate cluster size and reduce operational costs.

Control plane 120 is representative of a software service that orchestrates deployment of an application in compute cluster 140. Examples of control plane 120 include Kubernetes, Nomad, and Apache Mesos, among others. Control plane 120 may operate as a cloud-based service or be hosted on a server managed by the customer running applications in compute cluster 140. Control plane 120 includes cloud manager 121, controller 123, scheduler 125, key value store 127, and API server 129.

The Application Programming Interface (API) server 129 acts as a communication hub for the components of control plane 120, facilitating interactions between elements such as controller 123 and key value store 127. Additionally, the API server 129 serves as an interface between compute nodes 150 and control plane 120, enabling the deployment and removal of pods 157. API server 129 is in communication with cloud manager 121, controller 123, scheduler 125, key value store 127, and compute nodes 150. While API server 129 is shown in communication with one compute node 150 in FIG. 1 for clarity, it is to be understood that API server 129 is in communication with each compute node 150 in compute cluster 140.

Cloud Manager 121 interfaces with node management service 110. Cloud manager 121 receives the updated request parameters generated by integrated controller 113. Cloud manager 121 also provides node management service 110 with information about changed resources (e.g., updated replica numbers in workloads and indications when pods are unschedulable).

Controller 123 manages the scaling and deployment of pods 157 in compute cluster 140. When node management service 110 provides updated request parameters to cloud manager 121, controller 123 updates the corresponding workload's request parameter values in key value store 127. Controller 123 then configures pods with the updated parameters and deploys them to the appropriate compute nodes 150 identified by scheduler 125.

Scheduler 125 is configured to schedule pods to compute nodes 150. Scheduler 125 reads data from key value store 127 to identify created pods that are ready for scheduling. Scheduler 125 identifies nodes that have sufficient available compute capacity to accommodate the request parameters in the pending pods (where the request parameters are updated by node management service 110 as described above). Scheduler 125 binds each pending pod with a compute node 150 having sufficient capacity for deployment.

Key value store 127 represents a data store that holds parameters used by controller 123 to orchestrate and manage the lifecycle of pods 157 within compute cluster 140. Key value store 127 contains parameters for each workload, including request parameters (as determined by node management service 110), limit values, the number of replicas, and other configuration settings. Controller 123 accesses these parameters to ensure that the cluster operates efficiently, applying the correct resource allocations and scaling actions as needed.

Compute provider 130 is representative of a provider of compute resources, including compute nodes 150 for compute cluster 140. Examples of compute provider 130 include Amazon Web Services, Google Cloud, and IBM Cloud, among others.

Compute cluster 140 includes compute nodes 150. While three compute nodes 150 are shown in FIG. 1 for convenience, compute cluster 140 may include more compute nodes 150. For example, a compute cluster 140 running a large-scale application may include hundreds or thousands of compute nodes 150. Compute cluster 140 may be, for example, a Kubernetes cluster. A compute node 150 runs node agent 155 and one or more pods 157.

Compute node 150 may be a virtual machine provided by compute provider 130. Compute node 150 runs node agent 155 and one or more pods 157. Control plane 120 initializes compute node 150 by causing node agent 155 to run on compute node (where node agent 155 may be, for example, Kubelet). Node agent 155 performs various functions including monitoring pods 157 running on compute node 150, including registering the respective compute node 150 with API server 129, and monitoring the performance of pods 157 in the respective compute node 150.

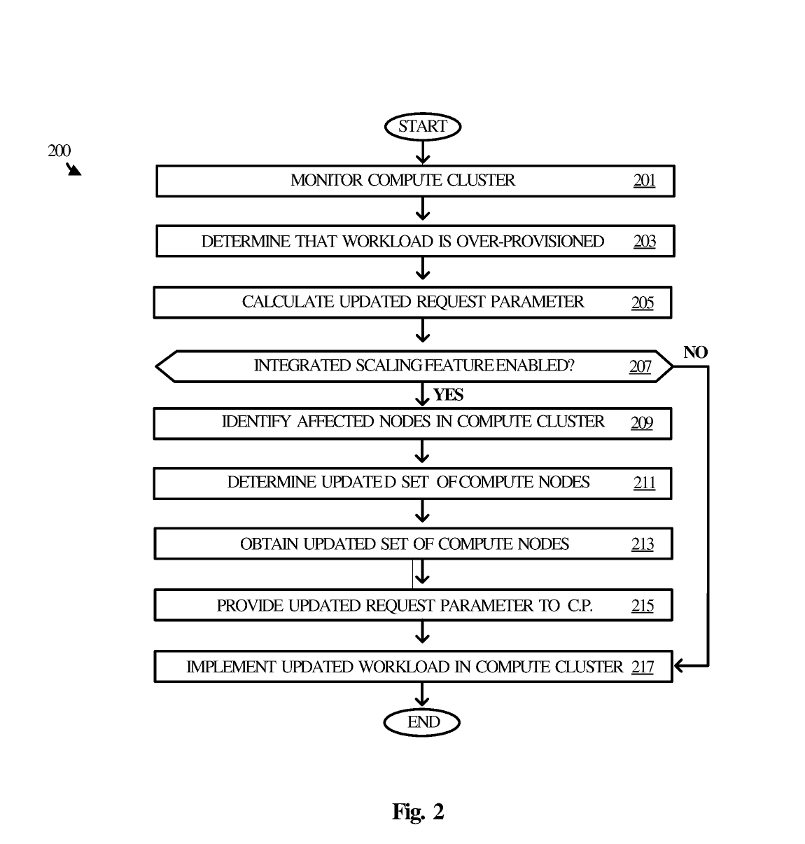

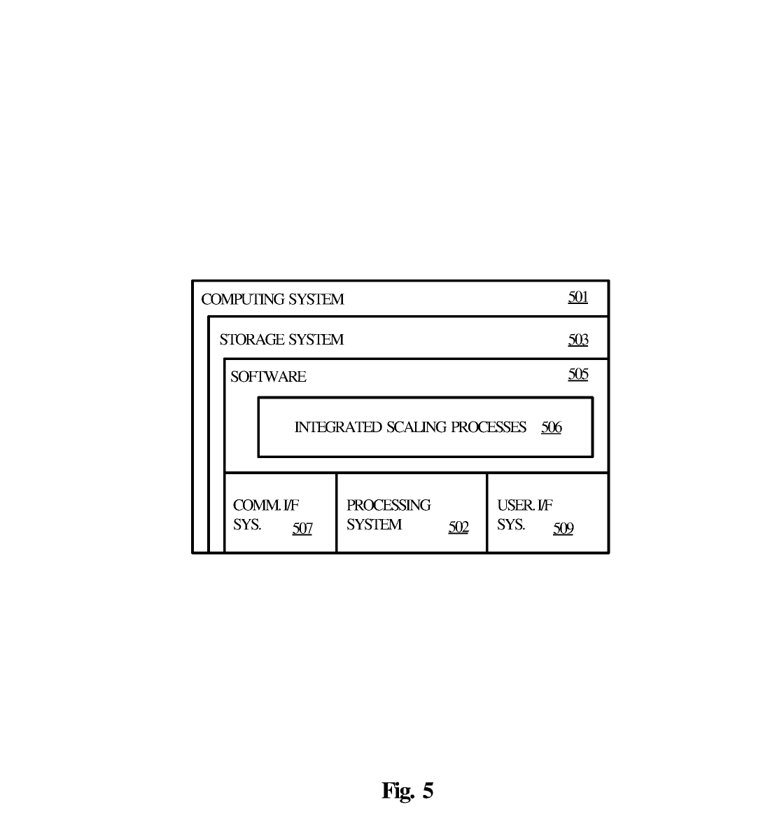

FIG. 2 illustrates an integrated scaling process performed by node management service 110 and control plane 120, represented by process 200. Process 200 may be employed by a computing device to provide integrated scaling, an example of which is provided by computing system 501 of FIG. 5. Process 200 may be implemented in program instructions (software and/or firmware) by one or more processors of the computing device. The program instructions direct the computing device to operate as follows, referring parenthetically to the steps in FIG. 2.

To begin node management service 110 monitors compute cluster 140 (step 201). Node management service 110 continually obtains usage statistics from compute cluster 140. Specifically, node management service monitors compute resources actually utilized in pods 157 operating in compute nodes 150, where each of pods 157 may each belong to one or more workloads operating in compute cluster 140.

Node management service 110 determines that a workload in compute cluster 140 is overprovisioned or under-provisioned (step 203). In computing environment 100 a workload (e.g., a “ReplicaSet” workload) is configured with specific resource parameters, including “requests” and “limits” for CPU and memory. The “request” parameter defines the minimum resources guaranteed to the workload, ensuring it has the necessary capacity to operate, while the “limit” sets the maximum resources it can consume. Overprovisioning occurs when these allocated resources significantly exceed the actual usage of the workload. For example, a ReplicaSet managing a web application might be configured with requests of 4 CPUs and 8 GB of memory per pod, but if the application only ever uses 1 CPU and 2 GB of memory, the workload may be considered overprovisioned. Conversely, under-provisioning occurs when the request value is not enough to meet the actual usage demands. Node management service 110 determines that a workload is overprovisioned or under-provisioned by monitoring the actual usage metrics received from compute cluster 140 and comparing these metrics with the request parameter of the workload.

Node management service 110 calculates an updated request parameter (step 205). The updated request parameter may include the minimum amount of available CPU and memory in a node 150 for a pod in the workload to be deployed to that node. The parameter can be derived using various methods, including analyzing historical usage data to align resource requests with typical usage patterns. Predictive techniques may also be employed, forecasting future resource needs based on trends and workload behavior, such as anticipating spikes in demand at specific times. Trained machine-learning models, or rules-based algorithms may be used to identify the request parameter in various implementations.

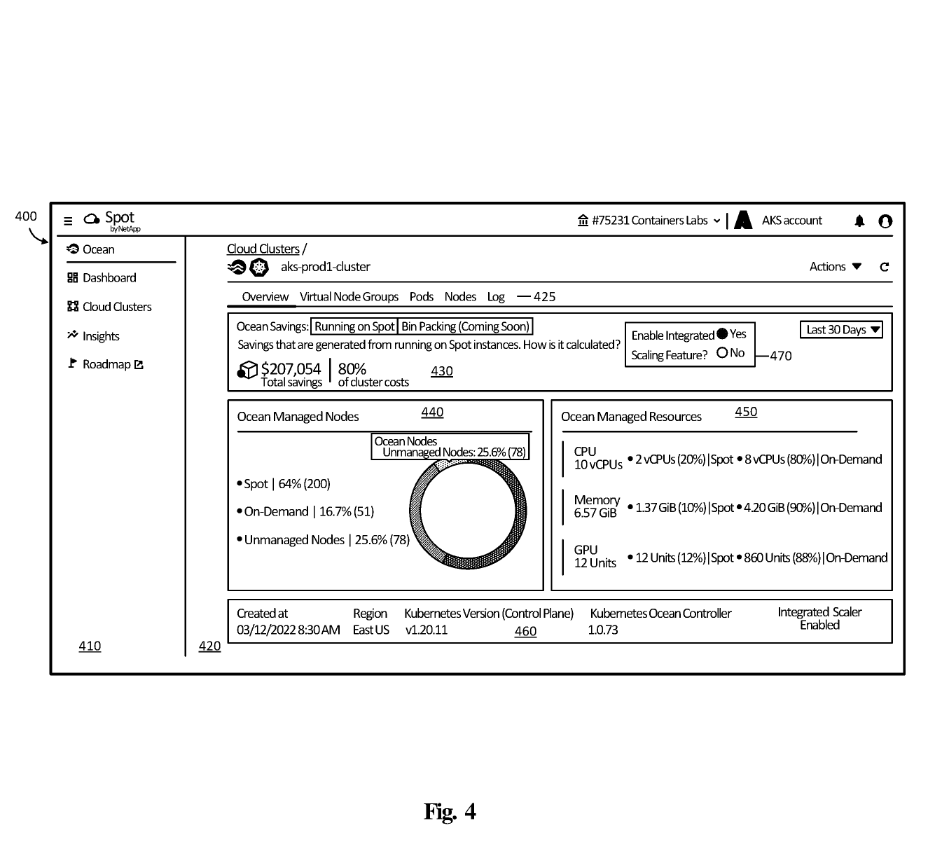

Node management service 110 determines if the integrated scaling feature is enabled (step 207). A customer may enable the integrated scaling feature by selecting an option in a user interface (e.g., using feature selection option 470 of FIG. 4). If the integrated scaling feature is not enabled, process 200 continues at step 217. If the integrated scaling feature is enabled, process 200 continues at step 209.

Node management service 110 identifies affected nodes 150 in compute cluster 140 (step 209). This is the first step of the node scaling process, which is automatically triggered upon calculation of the updated request parameter when the integrated scaling feature is enabled. The affected nodes in compute cluster 140 are those compute nodes 150 that run pods 157 in the workload with the updated request parameter.

Node management service 110 determines an updated set of compute nodes 150 to run the updated workload (step 211). To determine the updated set of compute nodes 150, integrated controller 113 runs a simulation to determine an efficient set of compute nodes for hosting the updated workload. This simulation involves simulating deployment of the pods with their updated request parameters across different configurations of compute nodes. The integrated controller assesses how these pods would perform if placed on nodes of varying sizes and capacities to find a node configuration that balances resource utilization, performance, and cost-effectiveness. For example, the simulation might test scenarios where the pods are deployed on a smaller number of larger nodes, or alternatively, distributed across a greater number of smaller nodes.

During the simulation, integrated controller 113 considers several factors, such as the computational power and memory capacity of each node, the communication overhead between nodes, and the potential impact on application performance. The simulation may be configured to perform cost-optimization in some implementations. To this end, integrated controller 113 evaluates the cost implications of different node configurations, looking for ways to minimize operational expenses. For instance, the simulation might reveal that consolidating the workload onto fewer, more powerful nodes can lower costs. Conversely, it might suggest distributing the pods more widely if that approach leads to better performance and lower long-term costs.

Node management service 110 obtains the updated set of compute nodes, from compute provider 130, for compute cluster 140 (step 213). Obtaining the updated set of compute nodes may include, for example, submitting a request for virtual machines (VMs) from compute provider 130. The request may specify, for example, the VM type, the VM size, and the Operating System image, among other settings. Node management service 110 receives, from compute provider 130, an identification of each VM provisioned in response to the request. Obtaining compute nodes 150 may further include deploying a node agent (e.g., Kubelet) to the compute nodes 150 and registering compute nodes 150 with a master controller of compute cluster 140.

Node management service 110 provides the updated request parameter to control plane 120 (step 215). Step 215 may be performed after obtaining the updated set of compute nodes of step 213 in some implementations.

Control plane 120 implements the updated workload in compute cluster 140 (step 217). Upon receiving the updated request parameters from the node management service, the control plane 120 takes the necessary actions to apply these changes within the compute cluster 140. This involves updating the resource specifications for the relevant workloads, such as ReplicaSets. Control plane 120 may deploy the workloads to the updated set of compute nodes 150 obtained by node management service 110.

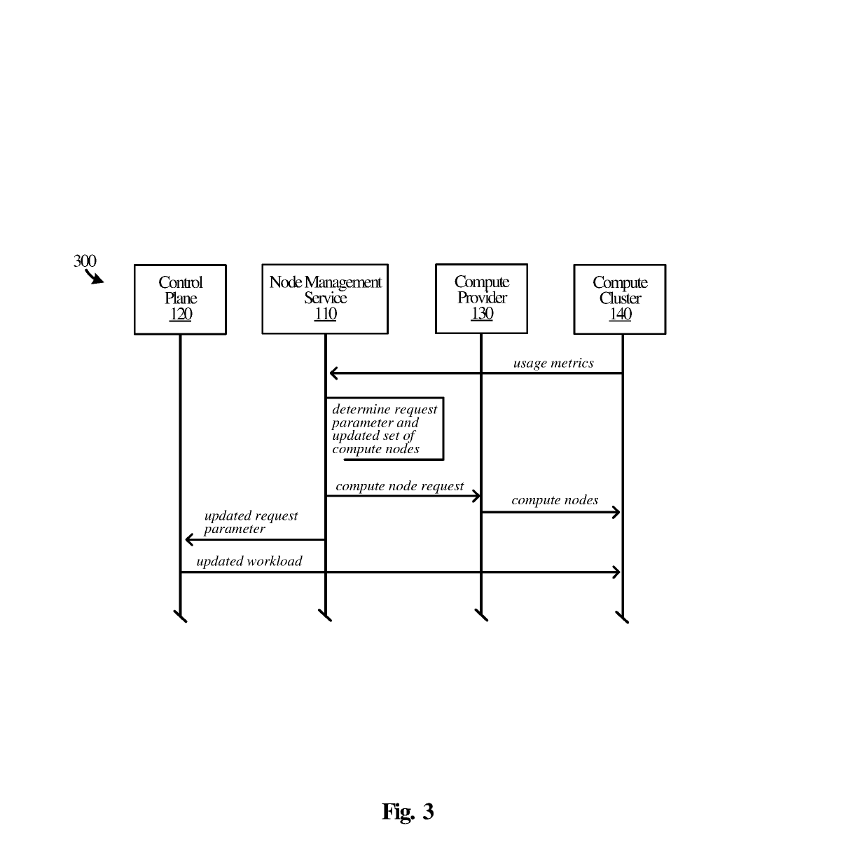

FIG. 3 illustrates an operation sequence of an application of process 200 in the context of compute environment 100 in an implementation, represented by sequence 300.

At the start of sequence 300, node management service 110 receives usage metrics from compute cluster 140, as discussed above with respect to step 201 of process 200. In response to determining that a workload is overprovisioned, node management service 110 determines an updated request parameter and an updated set of compute nodes in a unified, integrated process (see discussion of steps 205-211 in process 200 above). This integration of request right-sizing and node scaling allows an updated set of nodes for the updated workload to be proactively obtained; resulting in expending the scaling down of the size of the cluster. This process is more efficient than existing systems, in which nodes are not scaled down until the updated workload is already deployed in compute cluster 140. In the present system, the compute nodes may be obtained and added to compute cluster 140 before the updated workload is deployed.

Continuing with sequence 300, node management system 110 submits a compute node request to compute provider 130 to obtain the updated set of compute nodes. Compute provider 130 implements the updated set of compute nodes to compute cluster 140 (see discussion of step 213 of process 200 above). Node management service 110 provides the updated request parameter to control plane 120 (see discussion of step 215 of process 200 above). In some implementations, compute provider 130 may provide the updated request parameter to control plane 120 after the compute nodes are deployed in compute cluster 140. Control plane 120 deploys the updated workload to compute cluster 140 (see discussion of step 217 of process 200). Node management service 110 may mark the initial set of compute nodes 150 as unschedulable, such that when control plane 120 removes original pods to replace them with new pods 157 having the updated request parameter, the new pods are deployed to the updated set of nodes. Once the original pods in the original set of nodes are all removed, node management service 110 may remove the original set of nodes from compute cluster 140. Accordingly, the original set of nodes is quickly replaced by a more efficient and cost-effective set of nodes.

FIG. 4 illustrates user interface 400 provided to application owners in an implementation. User interface 400 may be generated and provided to application owners by a node management service such as node management service 110 of FIG. 1.

User interface 400 includes panel 410 and display 420, in an implementation. Panel 410 provides a list of different selectable services. In the example in FIG. 4, an owner has selected “cloud clusters” (referring, for example, to compute cluster 140 of FIG. 1). Display 420 provides information and configuration options to the owner, in one implementation. In the example in FIG. 4, display 420 includes selectable tabs 425, savings overview 430, node overview 440, resource overview 450, high-level overview 460, and feature selection option 470. It is noted that user interface 400 is exemplary; user interfaces in other implementations may have different views and arrangements.

Selectable tabs 425 are selectable by the owner for viewing information about various features of a compute cluster (e.g., compute cluster 140 of FIG. 1). In the example in FIG. 4, the owner has selected “Overview,” resulting in the display of savings overview 430, node overview 440, and resource overview 450.

Savings overview 430 displays savings to the owner resulting from usage of the node management service (e.g., node management service 110 of FIG. 1).

Node overview 440 displays a breakdown of the nodes in the compute cluster. Specifically, node overview 440 indicates how many nodes are managed by the node management service (e.g., node management service 110 of FIG. 1).

Resource overview 450 displays the resources managed by the node management service (e.g., node management service 110 of FIG. 1), including CPUs (Central Processing Units), Memory, and GPUs (Graphics Processing Units).

High-level overview 460 provides high level information about the compute cluster (e.g., compute cluster 140 of FIG. 1), the orchestration service (e.g., orchestration service 110 of FIG. 1) and the node management service (e.g., node management service 110 of FIG. 1). Feature selection option 470 provides the owner with the option to enable or disable an integrated scaling feature (as discussed above with respect to step 207 of process 200), where the predictive scaling feature may be an optional feature of the node management service (e.g., node management service 110 of FIG. 1).

FIG. 5 illustrates computing system 501, which is representative of any system or collection of systems in which the various applications, processes, services, and scenarios disclosed herein may be implemented. Examples of computing system 501 include, but are not limited to server computers, web servers, cloud computing platforms, and data center equipment, as well as any other type of physical or virtual server machine, container, and any variation or combination thereof. (In some examples, computing system 501 may also be representative of desktop and laptop computers, tablet computers, and the like.)

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 509. Processing system 502 is operatively coupled with storage system 503, communication interface system 507, and user interface system 509.

Processing system 502 loads and executes software 505 from storage system 503. Software 505 includes and implements integrated scaling processes 506, which is representative of the processes discussed with respect to the preceding Figures, such as process 200. When executed by processing system 502, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may include a microprocessor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, microcontroller units, graphical processing units, application specific processors, integrated circuits, application specific integrated circuits, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 503 may be implemented as a single storage device but may also be implemented across multiple storage devices or sub-systems co-located or distributed relative to each other. Storage system 503 may comprise additional elements, such as a controller capable of communicating with processing system 502 or possibly other systems.

Software 505 (including integrated scaling processes 506) may be implemented in program instructions and among other functions may, when executed by processing system 502, direct processing system 502 to operate as described with respect to the various operational scenarios, sequences, and processes illustrated herein. For example, software 505 may include program instructions for implementing integrated scaling processes and procedures as described herein.

A computer-implemented method for integrating workload right-sizing and node scaling according to some embodiments includes: monitoring usage statistics for a workload in a compute cluster to identify that the workload is overprovisioned; in response to identifying that the workload is overprovisioned, right-sizing the workload by adjusting a request parameter of the workload; and automatically scaling the compute cluster in response to the right-sizing, by: identifying an updated set of compute nodes for the compute cluster based on the adjusted request parameter, and obtaining the updated set of compute nodes from a compute provider.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for operating a node management service comprising:
modifying a request parameter for a workload comprising one or more pods in a compute cluster, wherein the request parameter identifies a minimum amount of compute resources for running each of the one or more pods;
identifying an initial set of nodes in the compute cluster affected by the modified request parameter;
determining an updated set of compute nodes in the compute cluster;
obtaining, from a compute provider, the updated set of compute nodes for the compute cluster; and
providing the modified request parameter to an orchestration service after obtaining the updated set of compute nodes.

2. The computer-implemented method of claim 1 wherein the determining the updated set of compute nodes comprises simulating deployment of the workload with the modified request parameter to multiple different sets of compute nodes.

3. The computer-implemented method of claim 1 further comprising:
monitoring usage statistics for the workload in the compute cluster; and
identifying that the workload is over-provisioned, wherein the modifying the request parameter is in response to identifying that the workload is over-provisioned.

4. A system for integrating workload right-sizing and node scaling in a compute cluster, the system comprising:
one or more processors; and
one or more memories operably coupled to the one or more processors and having stored thereon software instructions that, upon execution by the one or more processors, cause the one or more processors to:
modify a request parameter for a workload comprising one or more pods in a compute cluster, wherein the request parameter identifies a minimum amount of compute resources for running each of the one or more pods;
identify an initial set of nodes in the compute cluster affected by the modified request parameter;
determine an updated set of compute nodes in the compute cluster;
obtain, from a compute provider, the updated set of compute nodes for the compute cluster; and
provide the modified request parameter to an orchestration service after obtaining the updated set of compute nodes.

5. The system of claim 4 wherein the determining the updated set of compute nodes comprises simulating deployment of the workload with the modified request parameter to multiple different sets of compute nodes.

6. The system of claim 4 wherein the software instructions comprise further instructions that, upon execution by the one or more processors, cause the one or more processors to:
monitor usage statistics for the workload in the compute cluster; and
identify that the workload is over-provisioned, wherein the modifying the request parameter is in response to identifying that the workload is over-provisioned.

7. A computer-readable storage media device having program instructions stored thereon to integrate workload right-sizing and node scaling in a compute cluster, wherein the program instructions, upon execution by one or more processors, cause the one or more processors to:
modify a request parameter for a workload comprising one or more pods in a compute cluster, wherein the request parameter identifies a minimum amount of compute resources for running each of the one or more pods;
identify an initial set of nodes in the compute cluster affected by the modified request parameter;
determine an updated set of compute nodes in the compute cluster;
obtain, from a compute provider, the updated set of compute nodes for the compute cluster; and
provide the modified request parameter to an orchestration service after obtaining the updated set of compute nodes.

8. The computer-readable storage media device of claim 7 wherein the determining the updated set of compute nodes comprises simulating deployment of the workload with the modified request parameter to multiple different sets of compute nodes.

9. The computer-readable storage media device of claim 7 wherein the program instructions comprise further instructions that, upon execution by the one or more processors, cause the one or more processors to:
monitor usage statistics for the workload in the compute cluster; and
identify that the workload is over-provisioned, wherein the modifying the request parameter is in response to identifying that the workload is over-provisioned.
